(19) United States
(12) Patent Application Publication
(10) Pub. No.: US 2026/0301013 A1
(43) Pub. Date: Oct. 1, 2026

(54) SYSTEMS AND METHODS FOR INTELLIGENT CASTING OF DATA OBJECT CREATORS

(71) Applicant: rewardStyle, Inc., Dallas, TX (US)

(72) Inventors: William Kress BODIN, Austin, TX (US); Baxter Murrell BOX, Dallas, TX (US); Danielle Diehl DEER, Dallas, TX (US); David JARAMILLO, Durham, NC (US); Duy Van NGUYEN, Cary, NC (US)

(73) Assignee: rewardStyle, Inc., Dallas, TX (US)

(21) Appl. No.: 19/092,605

(22) Filed: Mar. 27, 2025

Related U.S. Application Data
(63) Continuation of application No. 17/405,705, filed on Aug. 18, 2021, now abandoned.
(60) Provisional application No. 63/068,273, filed on Aug. 20, 2020.

(51) Int. Cl. G06Q 30/0204; G06Q 50/00

(52) U.S. Cl. CPC G06Q 30/0204; G06Q 10/40

(57) ABSTRACT

A computer-implemented method for intelligent casting of data object creators may include receiving, from a manufacturing entity associated with a user interface, information identifying at least one object to be featured in a media post for presentation in the user interface. The method may include analyzing, by using a segmentation model and an object correlation engine, a plurality of data object creators to determine one or more classified data object creators for the at least one object. The analyzing may include classifying, by the segmentation model, one or more data object creators of the plurality of data object creators based on one or more of physical characteristics of the one or more data object creators or demographic characteristics of the one or more data object creators. The method may include receiving a selection of one of the one or more classified data object creators included in a returned list.

### TECHNICAL FIELD

Various embodiments of the present disclosure relate generally to online product advertising and social networking and, more particularly, to providing real-time automated support for social media creators, advertisers, and consumers.

### BACKGROUND

A social media creator may post photographs, video, and/or text to social media networking websites, including depictions and descriptions of consumer goods of interest to the creator and the creator's social media followers. These posts may include links to websites of retailers from whom the depicted items may be purchased. If a sale is made through these links, the creator may receive a commission on the sale. Influencers have an interest in improving and optimizing their social media posts to attract additional followers and to generate additional sales. However, many influencers lack the technical and marketing experience to effectively track and analyze their posts and sales performance. Social media followers, likewise, have an interest in connecting with influencers that match their interests, but may be unable to efficiently locate such influencers or to synthesize content between influencers to whom they are connected.

Solutions to these interests may be met by a platform provider that employs human effort to gather and distill the desired information, but this may be very time consuming and expensive. For example, consider a platform provider with more than 100,000 influencers as clients, of whom, say around 500 are “top performers.” If human advisers are employed to assist just the top performers, the cost may be, for example, on the order of $100,000 to $500,000. Expanding these services to all clients, however, would drive the costs to over $50,000,000 or more. Such an expenditure would be beyond the capabilities of most businesses, leaving the platform provider unable to fully support all of their clients. Thus, a need is felt to provide these services to social media influencers and consumers, at a cost that would be attainable by the platform provider.

The present disclosure is directed to overcoming one or more of these above-referenced challenges.

### SUMMARY OF THE DISCLOSURE

According to certain aspects of the disclosure, systems and methods are disclosed for features provided by an intelligent agent for app content and intelligent casting of social media creators.

In one embodiment, a computer-implemented method is disclosed for intelligent casting of social media creators, the method comprising: receiving, from a provider of goods or services, a request to match a social media post topic with a social media creator among a plurality of social media creators, accessing a database comprising a plurality of social media posts by the plurality of social media creators, analyzing each social media post among the plurality of social media posts, selecting a predetermined number of social media creators among the plurality of social media creators according a best match of the request to one or more attributes of each social media creator among the plurality of social media creators and the analysis of the plurality of social media posts, and returning a list of the selected social media creators.

In accordance with another embodiment, a system is disclosed for intelligent casting of social media creators, the system comprising: a data storage device storing instructions for intelligent casting of social media creators in an electronic storage medium; and a processor configured to execute the instructions to perform a method including: receiving, from a provider of goods or services, a request to match a social media post topic with a social media creator among a plurality of social media creators, accessing a database comprising a plurality of social media posts by the plurality of social media creators, analyzing each social media post among the plurality of social media posts, selecting a predetermined number of social media creators among the plurality of social media creators according a best match of the request to one or more attributes of each social media creator among the plurality of social media creators and the analysis of the plurality of social media posts, and returning a list of the selected social media creators.

In accordance with another embodiment, a non-transitory machine-readable medium storing instructions that, when executed by the a computing system, causes the computing system to perform a method for intelligent casting of social media creators, the method including: receiving, from a provider of goods or services, a request to match a social media post topic with a social media creator among a plurality of social media creators, accessing a database comprising a plurality of social media posts by the plurality of social media creators, analyzing each social media post among the plurality of social media posts, selecting a predetermined number of social media creators among the plurality of social media creators according a best match of the request to one or more attributes of each social media creator among the plurality of social media creators and the analysis of the plurality of social media posts, and returning a list of the selected social media creators.

In accordance with another embodiment, a computer-implemented method is disclosed for dynamic synthesis of social media content, the method comprising: receiving a request for a new social media post, the request comprising one or more of content keywords, time constraints, and geolocation constraints, accessing a database comprising a plurality of posts by a social media creator, analyzing each post among the plurality of posts, including text, photo content, video content, and metadata, the analysis of each post comprising one or more of a linguistic analysis of the text of the post, image recognition of objects in the photo content and video content, audio analysis of audio associated with the video content including speech-to-text processing, and analysis of metadata associated with each element of the post, extracting, from the plurality of posts, content elements related to the received request according to the analysis, synthesizing additional content based on the analysis, the additional content comprising one or more of new text elements according to the requested content keywords and the linguistic analysis of the text of each post among the plurality of posts, and synthesizing a new social media post comprising the extracted content items and the synthesized additional content items.

In accordance with another embodiment, a computer-implemented method is disclosed for automatic aggregation of social media content, the method comprising: receiving a request for aggregated social media content, the request comprising one or more of content keywords, time constraints, and geolocation constraints, accessing a database comprising a plurality of posts by one or more social media creators, analyzing each post among the plurality of posts, including text, photo content, video content, and metadata, the analysis of each post comprising one or more of a linguistic analysis of the text of the post, image recognition of objects in the photo content and video content, audio analysis of audio associated with the video content including speech-to-text processing, and analysis of metadata associated with each element of the post, extracting, from the plurality of posts, content elements related to the received request according to the analysis, and returning the extracted content

In accordance with another embodiment, a computer-implemented method is disclosed for guided in-store navigation, the method comprising: receiving an expression of interest in a product featured in a social media post, the request provided by way of a user's mobile device, extracting information of the requested product through analysis of the request and the social media post, the extracted information comprising one or more of a nearest retail store with the product in stock, price and stock information for the product at the retail store, travel directions to the retail store from the user's location or another location, and location of the product within the retail store, returning the extracted information to the user, and providing to the user, by way of the mobile device, navigation information to the product within the retail store, the navigation information comprising one or more of a store map, geolocation information, and Bluetooth beaconing.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an overview of embodiments of an intelligent agent for app content, according to one or more embodiments.

FIG. 2 depicts a user interface for an intelligent agent for app content, according to one or more embodiments.

FIG. 3 depicts a system architecture for an intelligent agent for app content, according to one or more embodiments.

FIG. 4 depicts a retailer web page including generated content, according to one or more embodiments.

FIG. 5 depicts a system architecture for intelligent casting of social media creators, according to one or more embodiments.

FIG. 6 depicts a portion of a system architecture for intelligent casting of social media creators, according to one or more embodiments.

FIG. 7 depicts a portion of a system architecture for intelligent casting of social media creators, according to one or more embodiments.

FIG. 8 depicts a portion of a system architecture for intelligent casting of social media creators, according to one or more embodiments.

FIG. 9 depicts a portion of a system architecture for intelligent casting of social media creators, according to one or more embodiments.

FIG. 10 depicts a portion of a system architecture for intelligent casting of social media creators, according to one or more embodiments.

FIG. 11 depicts a flowchart of a method of intelligent casting of social media creators, according to one or more embodiments.

FIGS. 12A-12D depict user interfaces for intelligent casting of social media creators, according to one or more embodiments.

### DETAILED DESCRIPTION OF EMBODIMENTS

Various embodiments of the present disclosure relate generally to providing real-time automated support for social media creators, advertisers, and consumers.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As discussed above, a social media creator may post to social media networking websites information relating to consumer goods of interest to the creator and the creator's social media followers, including links providing for the purchase of the displayed goods. A creator and the creator's followers may subscribe to an intelligent agent platform that supports, for example, the creator's posts, the electronic commerce functionality allowing for the purchase of the promoted items, as well as accounting and recordkeeping of the creator's post, sales commissions, etc. The creator's followers, as consumers, may connect with the creator through the same intelligent agent platform, and may, for example, use the intelligent agent platform to connect to other creators, combine content among multiple creators, etc.

### Intelligent Agent Platform

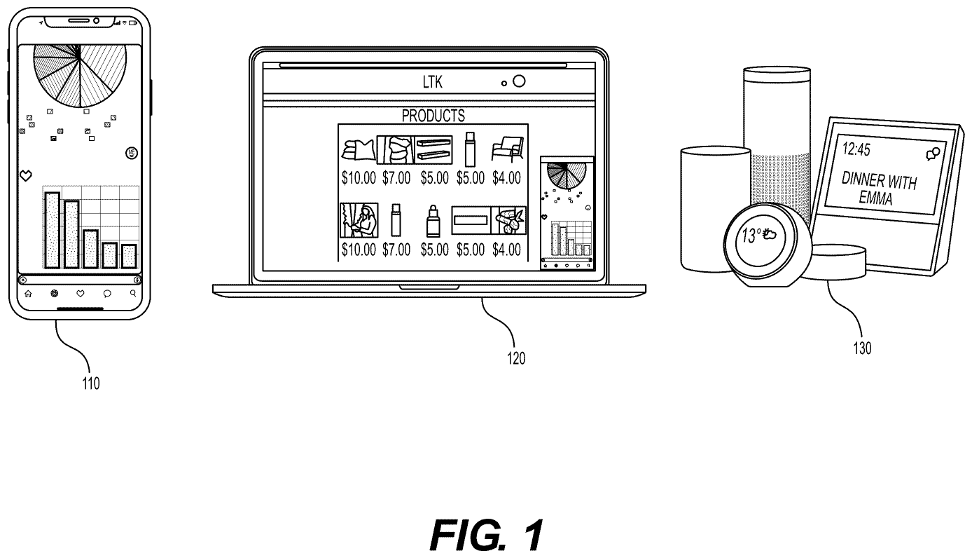

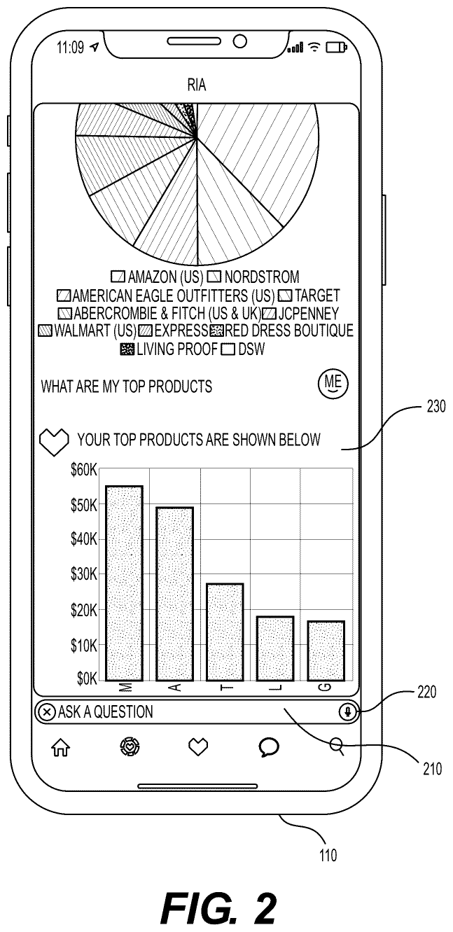

As shown in FIG. 1, the intelligent agent platform may be provided to the creator and followers, as end users, by way of, for example, a mobile app 110, a desktop application 120, or an automated virtual assistant 130. Other embodiments, such as, for example, integration with interactive functionality of an automobile's information and entertainment system, may also be provided. For clarity of description, the various embodiments will be discussed in the context of a mobile app 110. However, it is to be understood that any of the disclosed features and functionalities may be equally applied to other embodiments. FIG. 2 depicts a user interface for an intelligent agent for app content, such as mobile app 110. Details of the user interface will be discussed in greater detail below.

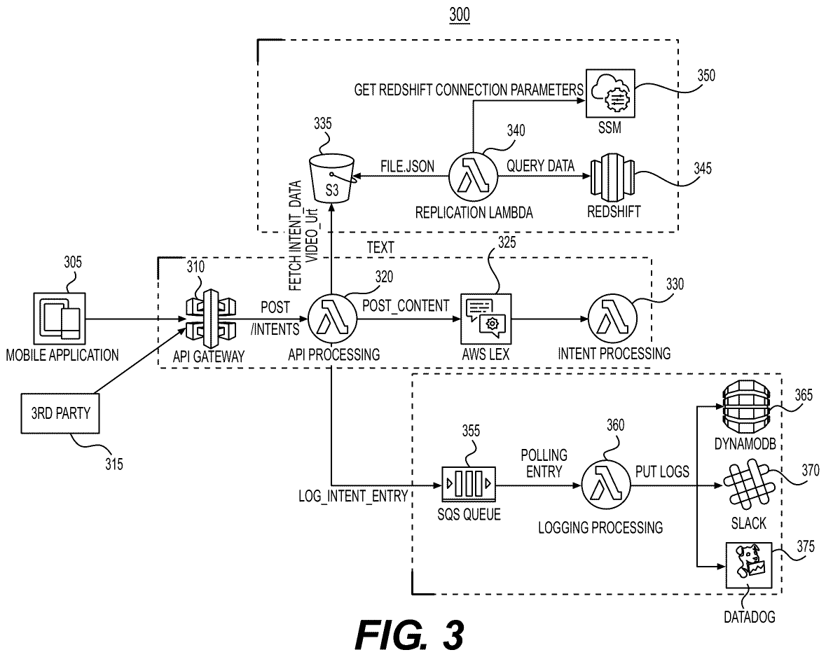

Data presented in such an intelligent agent for app content, such as is depicted in FIGS. 1 and 2, may be generated through an intelligent agent platform. An exemplary system architecture 300 for the intelligent agent platform is shown in FIG. 3. In general, system architecture 300 may comprise an API gateway 310, API processing module 320, language interface 325, and intent processing module 330 all configured to receive and process requests from mobile applications 305 and third parties 315. System architecture 300 may also comprise an object data storage device 335, replication lambda module 340, data warehouse 345, and system software manager (SSM) 350 for storing system configuration variables and settings. Separately, platform 300 may comprise a logging queue 355, logging processing lambda 360, database 365, collaboration interface 370, and cloud monitoring module 375.

Thus, by way of additional background and detail, in one non-limiting embodiment, the platform may include these components:

Mobile App 305—Provides artificial intelligence-driven support for creators, consumers, and advertisers.

API Gateway 310—Responsible for receiving requests from end-users of mobile app 305 and third parties 315. Processing by the gateway may include: verifying that the request is valid, managing usage plans for end users and third parties, and posting the request to API Processing Lambda 320.

API Processing Lambda 320—Invoked by APIs Gateway to process the incoming request. Processing may include: verifying whether required parameters are present in the incoming request, passing request to language interface 325, sending a log to logging queue 355 for intent logging, and process intent logic to return data to clients.

Language Interface 325—Processes request through conversational interfaces using voice and text input and provides request parameters to Intent Processing Lambda 330.

Intent Processing Lambda 330—Fulfills request and returns custom response to client.

Object data storage 335—Object storage for, for example, charts and video, etc. Used by API Processing Lambda 320 to return data to clients.

Replication Lambda 340—Invoked nightly for the gathering information from data warehouse. Depends on the business requirement to query to the data warehouse and get the needed data, then transform and store the data files to Object data storage 335.

Data warehouse 345—This is a data warehouse containing information for chart data. Replication lambda will query to this service to get the needed data.

System software manager (SSM) 350—Provides a secure means to store system configuration variables and settings such as, for example, connection parameters for Data warehouse 345.

Logging Queue 355—Queue for logging processing Lambda 360.

Logging Processing Lambda 360—Polling messages from Logging Queue 355, then stores messages to Database 365, and messages to Collaboration interface 370, and Cloud Monitoring 375.

Database 365—Used to store log of intent entries.

Collaboration Interface 370.

Cloud Monitoring Module 375.

The platform may be used to integrate with third-party service providers, such as, for example, a push notification service, a customer relationship management service, chat service providers, team communication and collaboration, and a virtual personal assistant, etc. Integration may be accomplished through an event bus in which internal platform events are circulated among the third-party service providers.

The intelligent agent platform, as provided in mobile app 110, may provide services that conventionally may be provided by manual human effort. However, conventional manual services may be unable to process a sufficient volume and breadth of data to satisfy the requirements of social media creators and followers. For example, such services may require the gathering, synthesis, and display of large volumes of foundational data in order to provide insights to the creator and followers. For example, the intelligent agent platform may deliver personalized real-time metrics for creators, contextual news, alerts, and updates for creators and followers, insights from retailers for creators, such as, for example, increases in product sales or changes in commissions, announcements of activities, or special events, and flexible views of the creator's past posts. Such real-time synthesis of data from disparate sources may be beyond the capabilities of manual human operations.

The user interface for the intelligent agent platform, such as provided in mobile app 110, may include, for example, as shown in FIG. 2, a browsable area 230 that may be scrollable vertically and horizontally, a text field 120 for submitting queries or commands to the intelligent agent platform, and a microphone icon for invoking speech recognition for entering queries or commands by voice rather than typing. The intelligent agent platform may respond to user queries and commands and display additional user interface elements, such as text, charts and graphs, as well as interactive interface elements, by way of an artificial intelligence engine. The artificial intelligence engine may be based on any methodologies of artificial intelligence, including, for example, data science, statistical analysis, machine learning, neural networks, heuristics, support vector machines, the Markov decision process, and natural language processing. Operation of the artificial intelligence engine will be described in detail below.

### Advertiser Support System

The artificial intelligence engine of the intelligent agent platform may further provide features directed to publishers of information about products and services, such as, for example, advertisers, brands and retailers, that engage with social media creators, such as “influencers,” who may promote brands and products through their online publications. Such features may be provided in a self-service or managed service scenario. For example, the artificial intelligence engine may provide a recommended distribution of products the advertiser wants to promote among social media creators based on an artificial intelligence-driven analysis of the products and social media creators. For example, the analysis may be based on attributes of the product, what products have been sold by each social media creator in the past, the return on advertising spend (ROAS) from past campaigns for each social media creator, the geolocation of each social media creator, the population ecosystem of consumers following each social media creator, etc. From this information, the artificial intelligence engine may discern a top N social media creators to sell the products, such as by calculating a probability of successful sales, where N is configurable by the advertiser.

The artificial intelligence engine may further identify conflicts between listed social media creators, such as, for example, the geolocation of the social media creators, social media creator demographics, population ecosystem of the social media creators' followers, etc., and may eliminate one of the conflicting social media creators, and add an additional social media creator in order to report N social media creators.

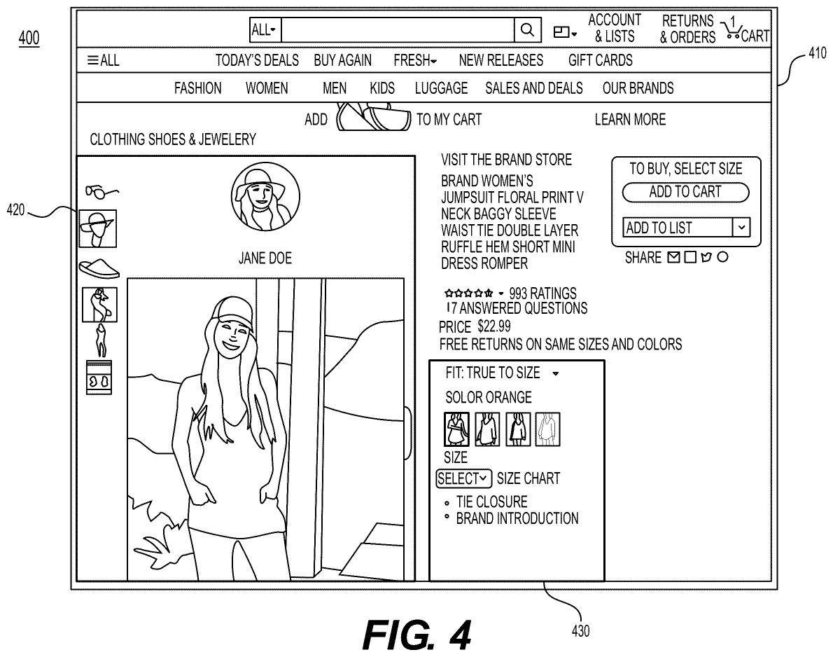

These features may be reflected in a retailer or brand's public profile, such as through their own social media posts, web site, print or electronic media advertising, etc. For example, FIG. 4 depicts a retailer web page 400 including generated content, according to one or more embodiments. As shown in FIG. 4, a retailer web page 410 may include information 420 highlighting a social media creator's engagement with a product, including, for example, text, images, and video, etc. Information 420 may be in addition to standard content of retailer web page 410 or may replace standard generic content. Retailer web page 410 may further include e-commerce elements 430 through which customer engagement with a product may be associated with the social media creator, thus allowing for crediting of any completed sales or other customer engagement to the social media creator, Such crediting may include, for example, commissions, fees, ratings, further direct engagement with the advertiser, etc.

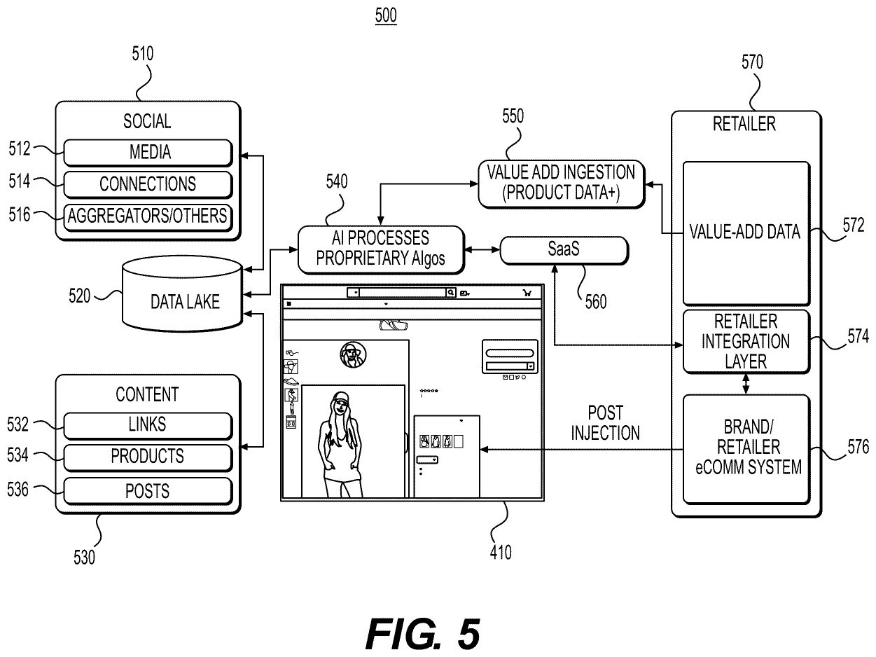

In addition to features providing information to a retailer or brand about social media engagement, some retailers or brands may wish to actively produce social media content in order to promote the retailer or brand and/or their products. One obstacle to such active participation in social media promotion is the section and engagement of one or more social media creators to creator and/or promote appropriate social media content. Features for selecting a social media creator to engage with a product and to produce additional or augmented social media content to include in a retailer or brand's public profile may be provided through a “nano-casting” service for providing highly targeted content based on, for example, the retailer or brand, attributes of a products, attributes of a consumer viewing the content, and attributes of a social media creator, etc. FIG. 5 depicts such a “nano-casting” system architecture and process flow 500 for intelligent casting of social media creators, according to one or more embodiments.

Process flow 500 may employ social data mining, combined with creator generated content, to determine a list of social media creators matching generic product content. An advertiser may specify a desired degree of match between a product profile and a social media creator to ensure that content generated by the social media creator matches the target product. Process flow 500 may determine the match of one or more social media creators to target product content and may perform a replacement of generic product information with social media creator generated content.

Process flow 500 may further support ingestion of retailer content in the form of extended product related data to refine an artificial intelligence (Al) modeling process and improve the overall matching results.

As shown in FIG. 5, one or more social media profiles 510 for a social media creator may be imported into database 520. Profiles 510 may include, for example, media posting sites 512, social connection sites 514, data aggregators and other sites, 516, etc. Data imported into database 520 may further include social media content 530 previously posted by the social media creator, Social media content 530 may include, for example, links 532 to other web sites or social media provided in social media content 530, information about products 534 featured or discussed in social media content 530, and/or posts 536, including text, images, video, etc., included in social media content 530, etc.

Information from database 520 may be employed by algorithms 540, to be aggregated and/or analyzed, such as by artificial intelligence methods, to create a profile of the social media creator, Details of such algorithms and data processing will be discussed in greater detail below.

In addition, an advertiser, such as retailer 570, may provide value-added data 572 to aid in the selection of social media creators. Value-added data 572 may include, for example, external products data, questions and answers posed by consumers such as through the retailer's web page or e-commerce portal, product fit information such as for garments, consumer comments, consumer ratings, a sentiment analysis of consumer comments, ratings, questions, and answers, weighting of product attributes, demographics of consumers previously purchasing or otherwise engaging with a product, data regarding commissions or fees paid to social media creators or others involved in sales or promotion of a product, information about current and/or in-progress sales, a return rate of the product, etc. Value-added data 572 may be pre-processed by value-added data ingestion module 550 prior to being employed by algorithms 540, to be aggregated or analyzed, such as by artificial intelligence methods, to be combined with aggregated and analyzed social media creator information. A result of such analysis, including, for example, one or more matches between a product and social media creators, generated or selected social media data for inclusion in an advertiser or retailer marketing information, etc. may be provided to a “software as a service” (SaaS) process 560 to allow the advertiser to integrate the analysis from algorithms 540 into marketing information, such as retailer web page 410. To this end, SaaS process 560 may interact with a retail integration layer 574 and e-commerce system 576 of a retailer 570 to inject social media content from a selected social media creator into the retailer's e-commerce web page 410, such as in portions 420 and 430 discussed above with respect to FIG. 4.

### Generating Personalized Insights

Graphical elements displayed in browsable area 230 may be selectable to request a text description of the displayed chart or graph. Alternatively, a request for a text description may be by way of an additional user interface element adjacent to, in incorporated within, the displayed chart or graph. The artificial intelligence engine may then provide a description that may replicate what a human being would have said about the chart or graph if the human had visibility to every piece of underlying data, and further had the technical and business acumen to provide a concise and meaningful analysis, etc. The description may include real-time creator specific insights, such as relationships (e.g., connections between creators and brands, between creators and other creators or users, etc.) that can be facilitated or improved or new relationships that may be suggested by the data in the chart or graph.

The artificial intelligence engine of the intelligent agent platform may provide direct access to information the creator previously may have had access to, but may have difficulty accessing at a later time, or may not be able to bring together at the same time. For example, the intelligent agent platform may provide prior posts by the creator, including, for example, text, images, video, etc., commissionable links in prior posts, an association of prior posts with particular products, either as associated with a campaign with a retailer, or posts made on an ad hoc basis. However, the intelligent agent platform may also provide information that may have been difficult or impossible for a creator to have obtained. For example, the intelligent agent platform may provide detailed metrics about the performance of prior posts, such as a number of visitors or followers, a number of links clicked on by visitors or followers, a number of sales resulting from clicked links, in raw numbers or dollar value, an amount of commissions earned, etc. This information may be presented in aggregate or may be broken down by post, by product, by retailer, etc.

The intelligent agent platform may further provide tools to help the creator improve the performance of their posts. For example, the intelligent agent platform may provide automated real-time suggestions to market products associated with past posts, such as by posting new content related to those products when the products are on sale or otherwise promoted by the retailer, thus potentially driving higher sales volume, or when the commissions paid by a retailer are increased, thus potentially driving increased revenue to the creator. The intelligent agent platform may provide coaching on improving posts. This may include, for example, suggestions of additional retailers to target or existing retailers to target with additional content, specific recommendations about post content, or a reminder to the creator to remind followers about past posts that may be currently relevant. The intelligent agent platform may also identify intellectual assets of the creator, such as photos and videos, and how they relate to current campaigns, or identify statistically favorable collections of products that may provide enhanced revenue or otherwise contribute to bottom line of the creator.

As discussed above, these features may conventionally be provided to the creator through human effort, but such a system may be expensive to operate and may not scale well to a larger number clients. One or more embodiments may, therefore, provide for these features by way of an artificial intelligence engine that may reduce the cost from human intervention and may provide more favorable scaling and net revenue to the platform provider. In addition, such an artificial intelligence engine may provide functionality that may be difficult or impossible to accomplish by human effort alone, as discussed in further detail below.

### Synthesizing a Dynamic Post

An artificial intelligence engine of an intelligent agent platform, according to one or more embodiments, may be able to access and integrate information in a greater volume and from a wider range of sources than can be practically accomplished by a human. The artificial intelligence engine may further be able to discern connections and trends that may not be apparent to a human. For example, the artificial intelligence engine may synthesize a dynamic post based on materials previously posted by the creator. The synthesized post may, for example, relate to new products, past products with new relevance, newly targeted retailers, seasonal marketing, etc., and may be delivered in draft form, such that the creator may post the synthesized post as-is or edit the synthesized post before posting. The content of the synthesized post may be based on sentiment analysis, including a profile of the creator's past posting habits and style, as well as an analysis of comments and feedback from readers. From this analysis, the artificial intelligence engine may know “how the creator talks” and, thus, may create a synthetic post that reflects the creator's personality and style. In a sense, the synthetic post may be considered to be created in the likeness of the creator. Such suggestions and synthetic posts may drive more consistent content posting, in terms of, for example, frequency, mix of products or retailers, voice, and style. The suggestions for synthetic posts are not mere reminders, however. The suggestions are material in nature, may be relevant to the creator's market, and may be actionable by the creator. This may fight complacency by the creator and further promote consistent volume and velocity of posts. In addition, the artificial intelligence engine may curate a list of potential products for the creator to promote, either in the context of synthesized posts or as a separate list of suggestions to the creator.

A computer-implemented method for dynamic synthesis of social media content, according to one or more embodiments, may include: receiving a request for a new social media post, the request comprising one or more of content keywords, time constraints, and geolocation constraints, accessing a database comprising a plurality of posts by a social media creator (author), analyzing each post among the plurality of posts, including text, photo content, video content, and metadata, the analysis of each post comprising one or more of a linguistic analysis of the text of the post, image recognition of objects in the photo content and video content, audio analysis of audio associated with the video content including speech-to-text processing, and analysis of metadata associated with each element of the post, extracting, from the plurality of posts, content elements related to the received request according to the analysis, synthesizing additional content based on the analysis, the additional content comprising one or more of new text elements according to the requested content keywords and the linguistic analysis of the text of each post among the plurality of posts, and synthesizing a new social media post comprising the extracted content items and the synthesized additional content items.

### Personalized Consumer View

In addition to features directed to creators, the artificial intelligence engine of the intelligent agent platform may provide features directed to consumers and followers of the creators. For example, the intelligent agent platform may provide information synthetically derived from following a number of creators, such as creators having common attributes, including demographics, population of followers, promoted products, brands, or retailers, or other attributes. Based on the derived information, a consumer may input a natural-language request, such as, “dress me in evening wear from my favorite creators.” The artificial intelligence engine may aggregate information across all creators the consumer follows to gather information about products potentially matching the query, use image recognition to ensure that identified products match the consumer query (e.g., the product is, in fact, “evening wear”), and, further, that the selected products are compatible (e.g., the products go together as an ensemble). This is just one example of this capability that may be provided by the artificial intelligence engine. A broad variety of consumer queries and commands may be supported. In such a scenario, the consumer's query may not be limited to creators consumer follows. A query may, for example, be answered based on all creators on platform. For example, the consumer may request suggestions for additional creators for casual wear that suits the consumer's style. Additional creators may be selected by the intelligent agent platform based on factors specific to the consumer, including the demographics of the consumer, attributes of the consumer's past product purchases, and attributes and profiles of the creators the consumer follows.

A computer-implemented method for automatic aggregation of social media content, according to one or more embodiments, may include: receiving a request for aggregated social media content, the request comprising one or more of content keywords, time constraints, and geolocation constraints, accessing a database comprising a plurality of posts by one or more social media creators, analyzing each post among the plurality of posts, including text, photo content, video content, and metadata, the analysis of each post comprising one or more of a linguistic analysis of the text of the post, image recognition of objects in the photo content and video content, audio analysis of audio associated with the video content including speech-to-text processing, and analysis of metadata associated with each element of the post, extracting, from the plurality of posts, content elements related to the received request according to the analysis, and returning the extracted content elements.

### Geolocation and In-Store Navigation

The platform and mobile app may also provide services to the consumer while shopping at a real-world brick-and-mortar store. For example, the mobile application may use in-store navigation features to direct the consumer to a product featured in a creator post. The creator may be credited with the sale based on the use of the creator post and the mobile application.

A computer-implemented method for guided in-store navigation, according to one or more embodiments may include: receiving an expression of interest (a follow or wish-list item) in a product featured in a social media post, the request provided by way of a user's mobile device, extracting information of the requested product through analysis of the request and the social media post, the extracted information comprising one or more of a nearest retail store with the product in stock, price and stock information for the product at the retail store, travel directions to the retail store from the user's location or another location, and location of the product within the retail store, returning the extracted information to the user, and providing to the user, by way of the mobile device, navigation information to the product within the retail store, the navigation information comprising one or more of a store map, geolocation information, and Bluetooth beaconing. This method may be further integrated with the retailers beaconing, floorplan and navigational system or systems to provide precise guidance to a consumer. Further, this integration can provide a means to measure dwell time in a certain area, gather product data from an electronic inventory, and additionally use that information to deliver relevant creator posts to a consumer.

### Intelligent Casting of Social Media Creators

The artificial intelligence engine of the intelligent agent platform may further provide features directed to publishers of information about products and services, such as, for example, advertisers, brands and retailers, that engage with social media creators, such as “influencers,” who may promote brands and products through their online publications. Such features may be provided in a self-service or managed service scenario. For example, the artificial intelligence engine may provide a recommended distribution of products the advertiser wants to promote among social media creators based on an artificial intelligence-driven analysis of the products and social media creators. For example, the analysis may be based on attributes of the product, what products have been sold by each social media creator in the past, the return on advertising expenses from past campaigns for each social media creator, the geolocation of each social media creator, the population ecosystem of consumers following each social media creator, etc. From this information, the artificial intelligence engine may discern a top N social media creators to sell the products, such as by calculating a probability of successful sales, where N is configurable by the advertiser. The artificial intelligence engine may further identify conflicts between listed social media creators, such as, for example, the geolocation of the social media creators, social media creator demographics, population ecosystem of the social media creators' followers, including the assessment of follower overlap, etc., and may eliminate one of the conflicting social media creators, and add an additional social media creator in order to report N social media creators.

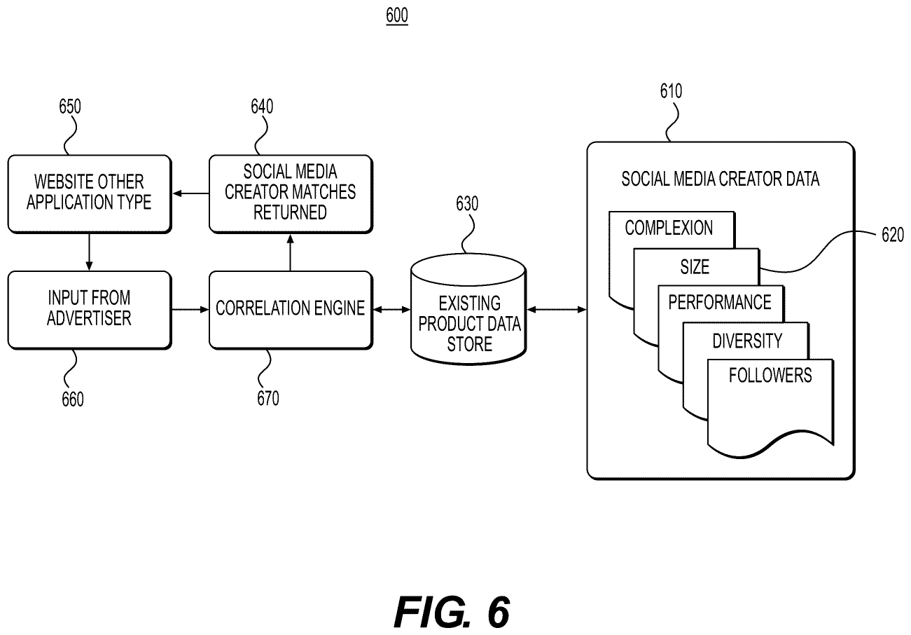

FIG. 6 depicts a portion of a system architecture 600 for intelligent casting of social media creators, according to one or more embodiments. As shown in FIG. 6, intelligent casting of social media creators may employ existing product data store 630 of data and accompanying metadata representing products. The products may be products of a current brand, advertiser, retailer, or manufacturer or may be products of other advertisers, retailers, or manufacturers. In addition, the products may have been previously promoted by one or more social media creators. Alternatively, the products may be expected or planned to be promoted by one or more social media creators in the future. This dataset may be generated through an image recognition algorithm which may use, for example, a training model dataset to identify objects and attributes relating to the product. The attributes associated with a product may include the category or categories that the product is associated with, for example, Fashion->Women_>Tops->Sweater->Cardigan. Additional attributes may include, but are not limited to, color, size, price, in or out of stock, availability date if not immediate, shipping time, etc.

When a brand, advertiser, retailer, or manufacturer (collectively referred to as “advertisers”) requests intelligent casting of social media creators, the advertiser may provide information 660 regarding one or more details about the product or products for which a campaign is to be created, as well as other criteria to be factored into the casting process. For example, if a product image is furnished, relating to the campaign, algorithms may analyze the image via an image classification system to match it to one or more products in existing product data store 630. Correlations may then be made by correlation engine 670 between the product information provided by the advertiser and the product information stored in existing product data store 630. These correlations between the desired product to sell and existing product data store 630 may further be correlated by correlation engine 670 to one or more social media creators. For example, existing product data store 630 may include or access social media creator data 610. For example, social media creator data 610 may include metrics 620 such as performance information such as the return on advertising spend (ROAS) for past campaigns involving the social media creator, physical and demographic characteristics of the social media creator, seasonal success, follower population, etc. Correlation engine 670 may use the information in existing product data store 630 and social media creator data 610 to determine one or more “best fit” social media creators 640 for the advertiser's criteria and products. Upon determination of one or more “best fit” social media creators 640, the advertiser, may, through a self-service or managed service environment, such as web site or other application embodiment 650, access the list of “best fit” social media creators 640.

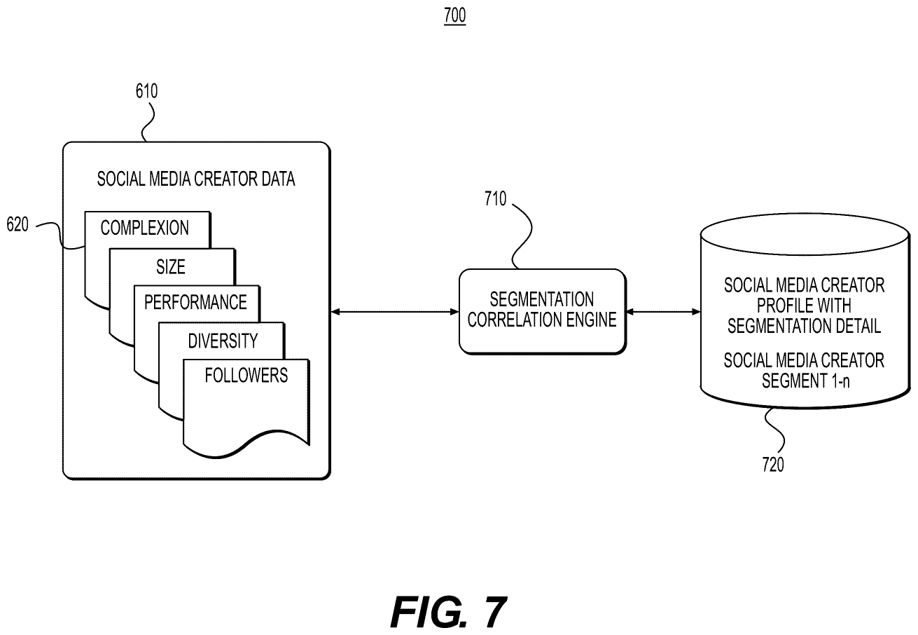

Determination of one or more “best fit” social media creators for a large population of social media creators, such as by the process depicted in FIG. 6, may employ a “segmentation model” to group similar social media creators. The model may be, for example, a machine learning model which may act as an intelligent agent to classify social media creators and group them into “segments” based on the creators' profile which may contain attributes such as geography, dominant brands, and other performance related parameters. For example, the machine learning model may be trained on algorithms that distinguish which brands the creator is producing more volume for in an order of primary, secondary, and tertiary brands. Those parameters can then be combined with performance based parameters to automatically determine and associate a creator with a segment. Segments can further be considered by a naming convention such as bronze, silver, gold and diamond, reflecting the perceived or measured value of the creator. FIG. 7 depicts a portion of a system architecture for intelligent casting of social media creators providing such a “segmentation model,” according to one or more embodiments. The components depicted in FIG. 7 may be provided, for example, as sub-components of correlation engine 670 depicted in FIG. 6. As shown in FIG. 7, a segmentation correlation engine 710 may process social media creator data 610 to determine a social media creator segmentation model 720, which may include, for example, social media creator profiles with segmentation detail, and social media creator segmentation data for one or more correlated social media creator segments. The social media creators included in social media creator data 610, upon being segmented in social media creator segmentation model 720, may be correlated to information about one or more products, such as product information provided by an advertiser or product information stored in existing product data store 630, depicted in FIG. 6.

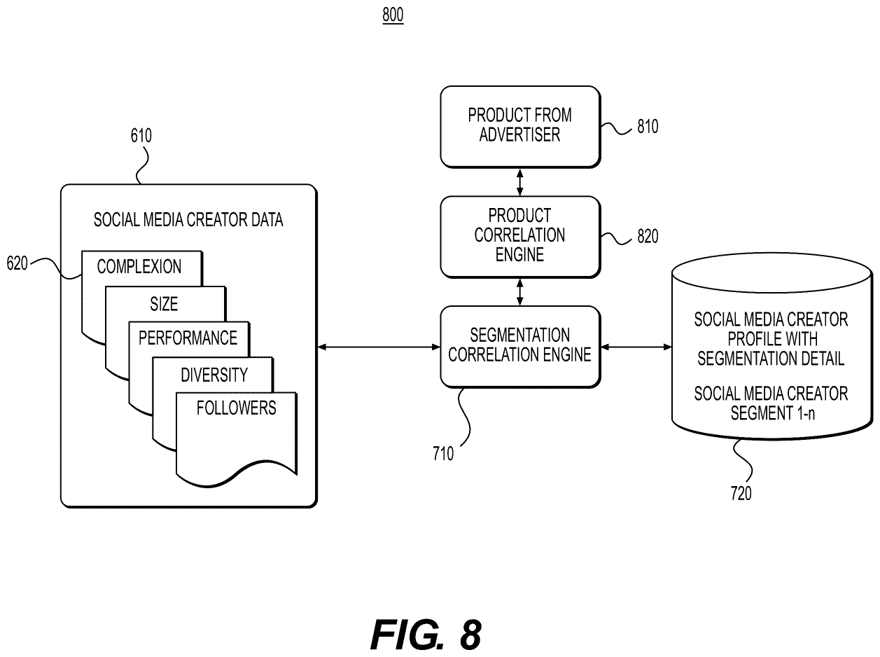

FIG. 8 depicts a portion of a system architecture for intelligent casting of social media creators including correlation of segmented social media creators with product information, according to one or more embodiments. The components depicted in FIG. 8 may be provided, for example, as sub-components of correlation engine 670 depicted in FIG. 6. As shown in FIG. 8, a product correlation engine 820 may process social media creator segmentation model 720 and product information 810 provided by an advertiser to correlate social media creators with advertiser products. For example, the correlation may be based on matches between the advertiser products and social media creators who have engaged with similar products with a predetermined level of success, as measured by performance metrics, such as, for example, ROAS, net sales, net sales increase during a social media creator's campaign, etc. Additional correlations may be drawn from measured levels (attributes) of ethnicity and diversity. These attributes can be further used to correlate matches to a desired demographic which can further be provided by the brand or retailer as part of the campaign metadata.

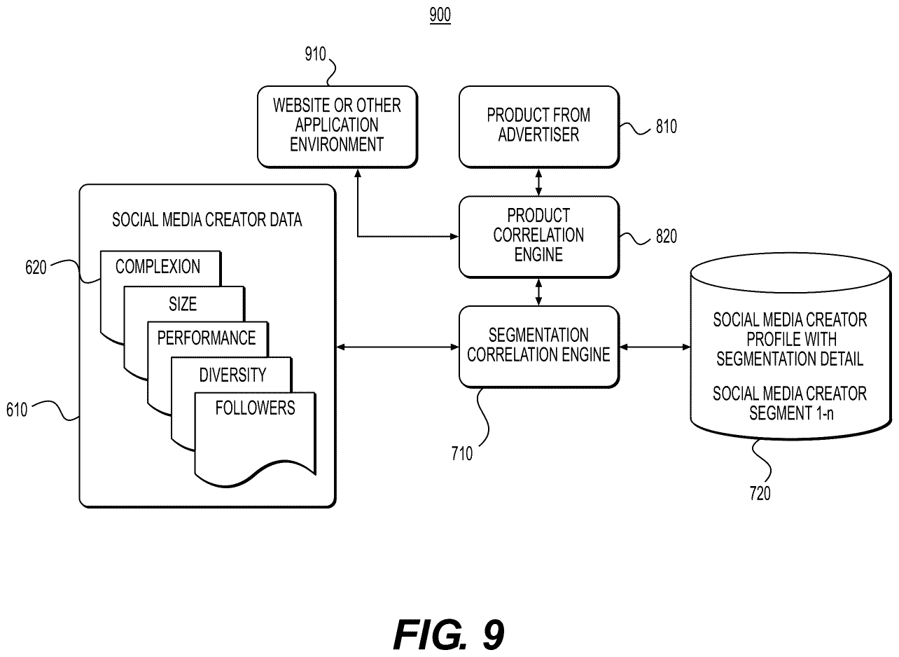

The correlation of social media creators with advertiser products may be further processed by product correlation engine 820 to generate a list of social media creators who may be desirable for engagement with the advertiser's products. Access to and interaction with the listed social media creators may be provided by way of a web site or application environment, such as, for example, a website or portal, a mobile application, a desktop application, or a software as a service (Saas) service. As shown in FIG. 9, a system architecture for intelligent casting of social media creators may include provision for interaction with an advertiser by way of web site or application environment 910, according to one or more embodiments. Application environment 910 may, in some cases, provide the parameters which correlation engine 820 may use to determine the best matches between brands, retailers and creators. The web site may take any form of engagement model and is not restricted to the embodiment of a traditional web site. This brand and retailer facing application may take the form of, for example, a mobile (smartphone), tablet, wearable, Android Auto, Apple Carplay, Virtual Personal Assistant (Alexa, Google Home, Apple Homekit) style application, etc. Additional implementations may include middleware, SaaS, and SDK embodiments that may further be integrated directly into a brand or retailers electronic data processing applications and environment.

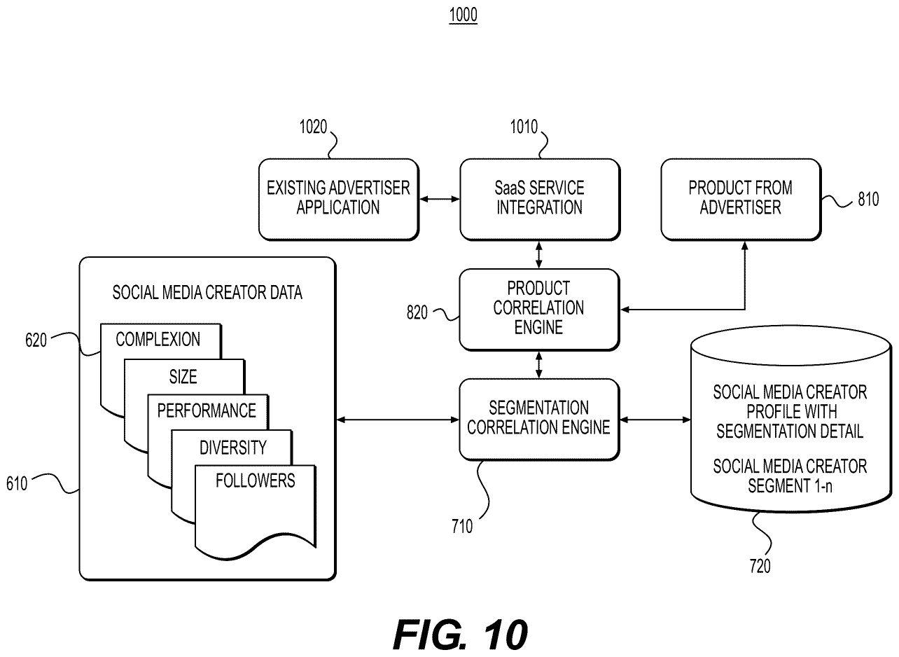

Implementation of the interaction between the advertiser and product correlation engine 820 as a SaaS service may further allow the advertiser to integrate the capabilities of product correlation engine 820 into their own business processes such as existing marketing applications. FIG. 10 depicts a portion of a system architecture for intelligent casting of social media creators including a SaaS service for interaction with an advertiser's applications and processes, according to one or more embodiments. The SaaS service may allow for varying implementations ranging from mobile to tablet, wearable, VPA's, Auto and other environments. The SaaS service may present, but is not limited to, RESTful style API's which return JSON or other data formats. This SaaS service embodiment may further allow for a very flexible and seamless integration into a variety of software systems and environments.

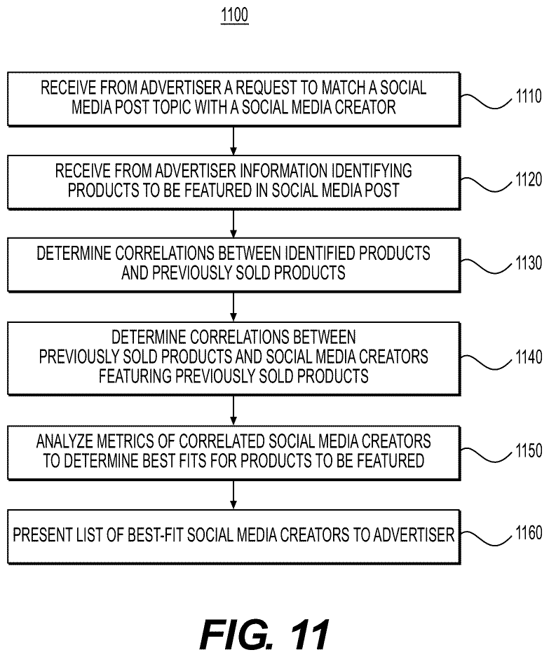

The system elements and operations described above may be used in a method for intelligent casting of social media creators. FIG. 11 depicts a flowchart of such a method, according to one or more embodiments.

As shown in FIG. 11, in operation 1110, a system for intelligent casting of social media creators may receive from an advertiser a request to match a social media post topic with a social media creator, The advertiser may be, for example, a retailer, manufacturer, or brand, etc., and the social media topic may be a product or service offered by the advertiser. The request may include, for example, one or more topic keywords, one or more content keywords, time constraints, and geolocation constraints, etc. In operation 1120, the system may receive from the advertiser information identifying the products or services to be featured in the social media post. In operation 1130, the system may determine one or more correlations between the social media post topic from the advertiser, including any identified products, and one or more products previously featured, sold, advertised, or promoted. In operation 1140, the system may determine one or more correlations between the previously featured products and one or more social media creators who have engaged with the previously featured, sold, advertised or promoted products. Determining the correlations in operation 1130 and 1140 may include analyzing each post among a plurality of posts by each social media creator, including text, photo content, video content, and metadata, etc. The analysis of each post may include one or more of a linguistic analysis of the text of the post, image recognition of objects in the photo content and video content, audio analysis of audio associated with the video content including speech-to-text processing, and analysis of metadata associated with each element of the post, etc. In operation 1150, the system may analyze one or more metrics of the correlated social media creators to determine one or more best fits for the advertiser's products or services. The selection may be according to the analysis of social media creator posts, and a best match of the request to one or more attributes of each social media creator among the plurality of social media creators. In operation 1160, the system may present a list of best-fit social media creators to the advertiser.

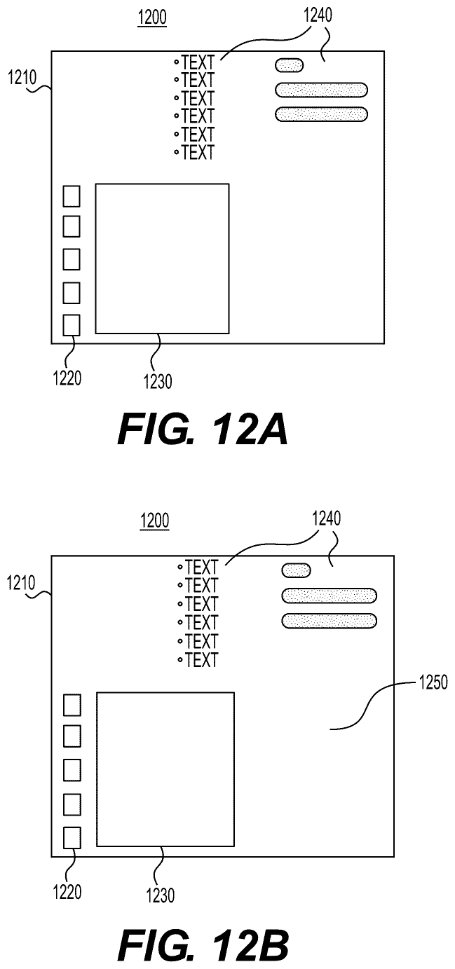

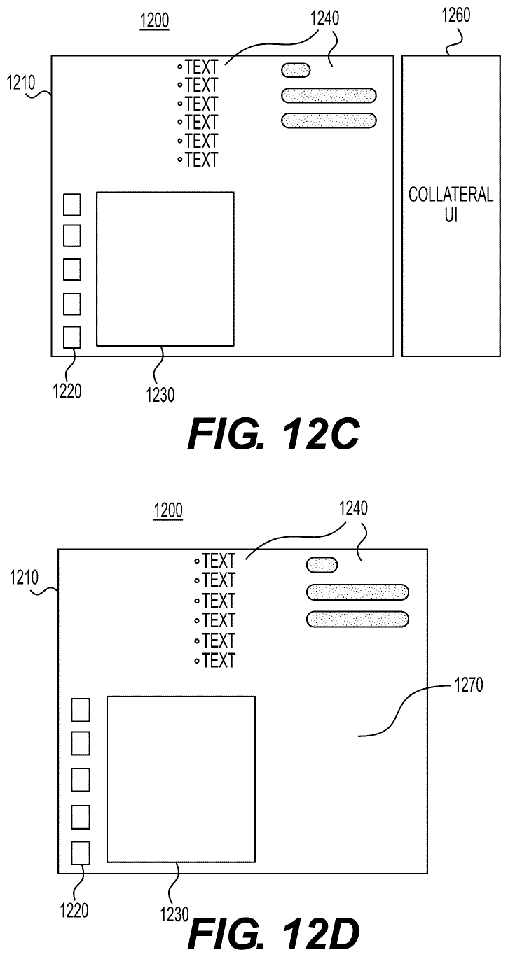

As discussed above, content generated by a selected social media creator may be integrated into an advertiser's existing applications or web sites, such as through “nano-casting” of social media creator content. FIGS. 12A-12D depict user interfaces for such integration in a method for intelligent casting of social media creators, according to one or more embodiments.

As shown in FIG. 12A, an advertiser's existing application or web site 1200 may include a user interface 1210, which may include a default product view 1230 and additional product view tiles 1220. User interface 1210, may further include other user interface elements 1240 that may not be modified through “nano-casting” of social media creator content.

Through integration with content generated by a selected social media creator, user interface 1210 may be modified through a “headless” browser plugin 1250, as shown in FIG. 12B, such that default product view 1230 and additional product view tiles 1220 may be replace by the generated content. Alternatively, user interface 1210 may be augmented with a collateral user interface, such as sidebar 1260, as shown in FIG. 12C. In addition, as discussed above, user interface 1210 may be modified through integration with the generated content by way of a software as a service (Saas) service 1270.

### Other Applications

The recommendation of a social media creator for a proposed social media topic, as discussed above with respect to FIGS. 4-12, may be combined with the capability to synthesize a social media post based on an social media creator's past posts to automatically provide a sample preview of a social media post on the requested topic.

Other features provided by the artificial intelligence engine may be relevant to multiple types of users of the platform. For example, the platform may provide recommendations for personalized educational instruction in which the artificial intelligence engine may find and integrate content from content delivery networks and streaming networks to deliver appropriate content for consumers and creators. In other embodiments, the platform may present the latest news information that may be determined to be relevant to the creators, consumers, or advertisers. The selection of news information may be determined automatically in real-time based on attributes of the creator, consumer, or advertiser to whom the content is recommended. As another example, an creator may want to find a third-party service provider, such as for photography services. The artificial intelligence engine may use attributes of the creator, such as geolocation, etc., to connect the creator with an appropriate service provider.

Although many of the exemplary functions of the intelligent agent platform are provided automatically by the artificial intelligence engine, in some circumstances, a creator may want to connect to a human representative. The artificial intelligence engine may determine the best human representative to assist the creator based on the attributes of the human representative, including their capabilities relative to selling, knowledge of and experience in the creator's market, etc.

Through application of these technologies, an intelligent agent platform embodying an artificial intelligence engine may provide services to creators to effectively track and analyze their posts and sales performance, and identify avenues to improve the performance of their posts in order to boost their bottom line. The disclosed embodiments may, likewise, assist social media followers, in connecting with creators that match their interests, and to synthesize content between creators to whom they are connected. Through the novel use of artificial intelligence technology, these benefits may be provided at a cost that would be attainable by the service provider.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Techniques discussed herein may be executed on one or more webpages. Such web pages may execute HTML, or other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method for intelligent casting of data object creators, the method comprising:
receiving, via an application programming interface (API) gateway and from a manufacturing entity associated with a user interface, information identifying at least one object to be featured in a media post for presentation in the user interface, wherein the user interface is configured to include one or more object view elements, and wherein the API gateway is configured to (i) manage a usage plan associated with the manufacturing entity, (ii) receive a request for intelligent casting from the manufacturing entity, (iii) verify that the request is valid, and (iv) post the request to an API processing module;
determining at least one correlation between the at least one object and at least one stored object, the at least one stored object stored in an object database, wherein determining the at least one correlation comprises analyzing, via an image classification system using a training model dataset, an image of the at least one object included in the received information, to identify attributes of the at least one object and to match the at least one object to the at least one stored object, the attributes including a category associated with the at least one object;
selecting a plurality of data object creators, the plurality of data object creators correlated to the at least one stored object, wherein selecting the plurality of data object creators comprises importing one or more profiles for each data object creator into the object database, the one or more profiles including media posting websites and data aggregators, and importing content previously posted by each data object creator, the content including links to other websites, information about objects featured in the content, and posts including text, images, and video;
analyzing, by using a segmentation model and an object correlation engine, the plurality of data object creators to determine one or more classified data object creators for the at least one object, the analyzing including:
classifying, by the segmentation model, one or more data object creators of the plurality of data object creators based on one or more of physical characteristics of the one or more data object creators or demographic characteristics of the one or more data object creators, wherein the segmentation model includes a machine learning model of an artificial intelligence engine;
grouping, by the segmentation model, the one or more classified data object creators into one or more segments based on a user profile corresponding to each classified data object creator, the user profile including at least one attribute; and
correlating, by the object correlation engine, the one or more classified data object creators corresponding to the respective one or more segments to the information identifying the at least one object, the correlating based on one or more matches between the at least one object and the one or more classified data object creators who engaged with at least one similar object with a predetermined level of success;
returning a list of the one or more classified data object creators corresponding to at least one of the one or more segments;
receiving a selection of one of the one or more classified data object creators included in the returned list;
dynamically synthesizing, by the artificial intelligence engine and for the selected one of the one or more classified data object creators included in the returned list, a synthetic media post representing a sample preview of a media post associated with the at least one object, based on analyzing at least one of text, photo content, video content, or metadata, of media posts previously created by the selected one of the one or more classified data object creators included in the returned list; and
receiving the media post featuring the at least one object from the selected one of the one or more classified data object creators included in the returned list, the received media post being generated based on the dynamic media post.

2. The computer-implemented method of claim 1, wherein the at least one attribute includes at least one of: a geography attribute, a dominant brand attribute, or a performance attribute.

3. The computer-implemented method of claim 1, wherein the selecting the plurality of data object creators includes analyzing at least one media post by at least one of the plurality of data object creators.

4. The computer-implemented method of claim 3, wherein the analyzing the at least one media post includes performing one or more of: a linguistic analysis of text in the at least one media post, an image recognition of at least one object in photo content and/or video content of the at least one media post, an audio analysis of audio associated with the video content, or a metadata analysis associated with at least one element of the at least one media post.

5. The computer-implemented method of claim 1, wherein the at least one stored object has been previously promoted by the plurality of data object creators.

6. The computer-implemented method of claim 1, wherein the machine learning model is trained by one or more algorithms that determine an object volume each of the one or more data object creators produces for one or more brands, and wherein the object volume is determined in an order of one or more primary brands, one or more secondary brands, or one or more tertiary brands.

7. The computer-implemented method of claim 1, the method further comprising:
naming, by the segmentation model, the one or more segments using a naming convention, the naming convention reflecting a measured value of at least one data object creator of the plurality of data object creators.

8. A system for intelligent casting of data object creators, the system comprising:
at least one data storage device storing instructions for intelligent casting of data object creators in an electronic storage medium; and
at least one processor configured to execute the instructions to perform a method including:
receiving, via an application programming interface (API) gateway and from a manufacturing entity associated with a user interface, information identifying at least one object to be featured in a media post for presentation in the user interface, wherein the user interface is configured to include one or more object view elements, and wherein the API gateway is configured to (i) manage a usage plan associated with the manufacturing entity, (ii) receive a request for intelligent casting from the manufacturing entity, (iii) verify that the request is valid, and (iv) post the request to an API processing module;
determining at least one correlation between the at least one object and at least one stored object, the at least one stored object stored in an object database, wherein determining the at least one correlation comprises analyzing, via an image classification system using a training model dataset, an image of the at least one object included in the received information, to identify attributes of the at least one object and to match the at least one object to the at least one stored object, the attributes including a category associated with the at least one object;
selecting a plurality of data object creators, the plurality of data object creators correlated to the at least one stored object, wherein selecting the plurality of data object creators comprises importing one or more profiles for each data object creator into the object database, the one or more profiles including media posting websites and data aggregators, and importing content previously posted by each data object creator, the content including links to other websites, information about objects featured in the content, and posts including text, images, and video;
analyzing, by using a segmentation model and an object correlation engine, of the plurality of data object creators to determine one or more classified data object creators for the at least one object, the analyzing including:
classifying, by the segmentation model, one or more data object creators of the plurality of data object creators based on one or more of physical characteristics of the one or more data object creators or demographic characteristics of the one or more data object creators, wherein the segmentation model includes a machine learning model of an artificial intelligence engine;
grouping, by the segmentation model, the one or more classified data object creators into one or more segments based on a user profile corresponding to each classified data object creator, the user profile including at least one attribute; and
correlating, by the object correlation engine, the one or more classified data object creators corresponding to the respective one or more segments to the information identifying the at least one object, the correlating based on one or more matches between the at least one object and the one or more classified data object creators who engaged with at least one similar object with a predetermined level of success;
returning a list of the one or more classified data object creators corresponding to at least one of the one or more segments;
receiving a selection of one of the one or more classified data object creators included in the returned list;
dynamically synthesizing, by the artificial intelligence engine and for the selected one of the one or more classified data object creators included in the returned list, a synthetic media post representing a sample preview of a media post associated with the at least one object, based on analyzing at least one of text, photo content, video content, or metadata, of media posts previously created by the selected one of the one or more classified data object creators included in the returned list; and
receiving the media post featuring the at least one object from the selected one of the one or more classified data object creators included in the returned list, the received media post being generated based on the dynamic media post.

9. The system of claim 8, wherein the at least one attribute includes at least one of: a geography attribute, a dominant brand attribute, or a performance attribute.

10. The system of claim 8, wherein the selecting the plurality of data object creators includes analyzing at least one media post by at least one of the plurality of data object creators.

11. The system of claim 10, wherein the analyzing the at least one media post includes performing one or more of: a linguistic analysis of text in the at least one media post, an image recognition of at least one object in photo content and/or video content of the at least one media post, an audio analysis of audio associated with the video content, or a metadata analysis associated with at least one element of the at least one media post.

12. The system of claim 8, wherein the at least one stored object has been previously promoted by the plurality of data object creators.

13. The system of claim 8, wherein the machine learning model is trained by one or more algorithms that determine an object volume each of the one or more data object creators produces for one or more brands, and wherein the object volume is determined in an order of one or more primary brands, one or more secondary brands, or one or more tertiary brands.

14. The system of claim 8, the method further comprising:
naming, by the segmentation model, the one or more segments using a naming convention, the naming convention reflecting a measured value of at least one data object creator of the plurality of data object creators.

15. One or more non-transitory machine-readable media storing instructions that, when executed by one or more processors, cause the one or more processors to perform a method for intelligent casting of data object creators, the method including:
receiving, via an application programming interface (API) gateway and from a manufacturing entity associated with a user interface, information identifying at least one object to be featured in a media post for presentation in the user interface, wherein the user interface is configured to include one or more object view elements, and wherein the API gateway is configured to (i) manage a usage plan associated with the manufacturing entity, (ii) receive a request for intelligent casting from the manufacturing entity, (iii) verify that the request is valid, and (iv) post the request to an API processing module;
determining at least one correlation between the at least one object and at least one stored object, the at least one stored object stored in an object database, wherein determining the at least one correlation comprises analyzing, via an image classification system using a training model dataset, an image of the at least one object included in the received information, to identify attributes of the at least one object and to match the at least one object to the at least one stored object, the attributes including a category associated with the at least one object;
selecting a plurality of data object creators, the plurality of data object creators correlated to the at least one stored object, wherein selecting the plurality of data object creators comprises importing one or more profiles for each data object creator into the object database, the one or more profiles including media posting websites and data aggregators, and importing content previously posted by each data object creator, the content including links to other websites, information about objects featured in the content, and posts including text, images, and video;
analyzing, by using a segmentation model and an object correlation engine, the plurality of data object creators to determine one or more classified data object creators for the at least one object, the analyzing including:
classifying, by the segmentation model, one or more data object creators of the plurality of data object creators based on one or more of physical characteristics of the one or more data object creators or demographic characteristics of the one or more data object creators, wherein the segmentation model includes a machine learning model of an artificial intelligence engine;
grouping, by the segmentation model, the one or more classified data object creators into one or more segments based on a user profile corresponding to each classified data object creator, the user profile including at least one attribute; and
correlating, by the object correlation engine, the one or more classified data object creators corresponding to the respective one or more segments to the information identifying the at least one object, the correlating based on one or more matches between the at least one object and the one or more classified data object creators who engaged with at least one similar object with a predetermined level of success;
returning a list of the one or more classified data object creators corresponding to at least one of the one or more segments;
receiving a selection of one of the one or more classified data object creators included in the returned list;
dynamically synthesizing, by the artificial intelligence engine and for the selected one of the one or more classified data object creators included in the returned list, a synthetic media post representing a sample preview of a media post associated with the at least one object, based on analyzing at least one of text, photo content, video content, or metadata, of media posts previously created by the selected one of the one or more classified data object creators included in the returned list; and
receiving the media post featuring the at least one object from the selected one of the one or more classified data object creators included in the returned list, the received media post being generated based on the dynamic media post.

16. The one or more non-transitory machine-readable media of claim 15, wherein the at least one attribute includes at least one of: a geography attribute, a dominant brand attribute, or a performance attribute.

17. The one or more non-transitory machine-readable media of claim 15, wherein the selecting the plurality of data object creators includes analyzing at least one media post by at least one of the plurality of data object creators.

18. The one or more non-transitory machine-readable media of claim 17, wherein the analyzing the at least one media post includes performing one or more of: a linguistic analysis of text in the at least one media post, an image recognition of at least one object in photo content and/or video content of the at least one media post, an audio analysis of audio associated with the video content, or a metadata analysis associated with at least one element of the at least one media post.

19. The one or more non-transitory machine-readable media of claim 15, wherein the machine learning model is trained by one or more algorithms that determine an object volume each of the one or more data object creators produces for one or more brands, and wherein the object volume is determined in an order of one or more primary brands, one or more secondary brands, or one or more tertiary brands.

20. The one or more non-transitory machine-readable media of claim 15, the method further including:
naming, by the segmentation model, the one or more segments using a naming convention, the naming convention reflecting a measured value of at least one data object creator of the plurality of data object creators.
